(19) United States
(12) Patent Application Publication
(10) Pub. No.: US 2026/0175297 A1
(43) Pub. Date: Jun. 25, 2026

(54) LASER ADDITIVE MANUFACTURING DEVICE FOR DISORDERING INTERFACE OF HIGH-STRENGTH AND TOUGHNESS TITANIUM ALLOY-ALUMINUM ALLOY HETEROGENEOUS MATERIAL AND METHOD THEREOF

(71) Applicant: NANJING UNIVERSITY OF AERONAUTICS AND ASTRONAUTICS, Jiangsu (CN)

(72) Inventors: Dongdong GU, Jiangsu (CN); Guangjing HUANG, Jiangsu (CN); Kaijie LIN, Jiangsu (CN); Hong LIU, Jiangsu (CN); Ziqi GUO, Jiangsu (CN); He SUN, Jiangsu (CN)

(73) Assignee: NANJING UNIVERSITY OF AERONAUTICS AND ASTRONAUTICS, Jiangsu (CN)

(21) Appl. No.: 19/432,147

(22) Filed: Dec. 24, 2025

(30) Foreign Application Priority Data
Dec. 25, 2024 (CN) 202411926070.X

(51) Int. Cl. B22F 10/85; B22F 10/28; B22F 12/55; B33Y 10/00; B33Y 30/00; B33Y 50/02; B33Y 70/00

(52) U.S. Cl. CPC B22F 10/85; B22F 10/28; B22F 12/55; B33Y 10/00; B33Y 30/00; B33Y 50/02; B33Y 70/00; B22F 2301/205

(57) ABSTRACT

A laser additive manufacturing device for disordering an interface of a high-strength and toughness titanium alloy-aluminum alloy heterogeneous material and a method thereof. The method includes the following steps: Step 1, integrally planning a laser printing strategy of a target component, Step 2, preparing laser printing powder, Step 3, preparing the laser printing, Step 4, printing and forming the titanium alloy part, Step 5, printing and forming the grain boundary disordered interface part, and Step 6, printing and forming the aluminum alloy part.

### CROSS-REFERENCE TO RELATED APPLICATION

This application claims the priority benefit of China application serial no. 202411926070.X, filed on Dec. 25, 2024. The entirety of the above-mentioned patent application is hereby incorporated by reference herein and made a part of this specification.

### BACKGROUND

### Technical Field

The present disclosure relates to a laser additive manufacturing device for disordering an interface of a high-strength and toughness titanium alloy-aluminum alloy heterogeneous material and a method thereof.

### Description of Related Art

Light alloy material is the first selection for implementing the lightweight modern aerospace equipment. The level of the development and application of the light alloy material not only reflects the advance of the science and technology of the country, but also reflects the economic strength. Currently, the quantity of the light alloy material used by a country is an important indicator for measuring the aerospace and military strength of the country. The titanium alloy is widely favored for the high specific strength, good corrosion resistance and high temperature resistance, and the aluminum alloy is widely used for the low density, excellent electrical and thermal conductivity and good processability. The light alloy and the titanium alloy have become the indispensable key materials in the fields of the aerospace, automobiles, ships, and national defense. As the lighter and higher performance of the metal components are required by the aerospace field, the titanium alloy/aluminum alloy heterogeneous material is emerged. However, there are still many technical difficulties during the process of preparing the titanium-aluminum heterogeneous material.

A large quantity of brittle intermetallic compounds are produced by the metallurgical reaction generated on the heterogeneous material interface between the aluminum alloy and the titanium alloy. The atomic arrangement of the intermetallic compounds is in a long-range order, which results in a little quantity of slip systems and high energy required for dislocation movement, so that the overall mechanical property of the component is poor. In order to fully exploit the potential of the titanium-aluminum heterogeneous material, it is urgent to develop a novel preparation method to eliminate this technical difficulty.

In recent years, Laser Powder Bed Fusion (LPBF) technique has shown the significant advantages in the aspect on the complex component manufacturing. The powder with thin layer is rapidly fused, solidified and laid by the LPBF through a high-energy laser beam along a preset path point by point, line by line and layer by layer, finally a three-dimensional solid component is formed, which has the characteristics of highly free design, high material utilization and precision forming. At present, LPBF technique has been successfully applied in the high-tech fields such as the aerospace and national defense, especially in the preparation of the high-performance titanium alloy, aluminum alloys and nickel-based high-temperature alloy. However, since the brittle ordered intermetallic compound phases are inevitably generated during the LPBF manufacturing of the titanium alloy-aluminum alloy heterogeneous material due to the metallurgical reaction, the performance of the titanium alloy-aluminum alloy heterogeneous material is deteriorated, it is urgent to develop a suitable disordering method for the intermetallic compounds at the interface to improve the mechanical property of the titanium alloy-aluminum alloy heterogeneous material.

### SUMMARY

The objectives of the present disclosure are to provide a laser additive manufacturing method for disordering an interface of a high-strength and toughness titanium alloy-aluminum alloy heterogeneous material, so as to solve the problem of the low mechanical property caused by the intermetallic compounds at the interface in the current LPBF preparation of the titanium alloy-aluminum alloy heterogeneous material.

In order to achieve the above technical objectives, the following technical solutions are adopted by the present disclosure.

Provided is a laser additive manufacturing method for disordering an interface of a high-strength and toughness titanium alloy-aluminum alloy heterogeneous material, which comprises following steps.

In Step 1, a laser printing strategy for a target component is integrally planned.

The target component is divided into three parts from top to bottom as a whole, and the three parts correspond to a titanium alloy part at a bottom of the target component, a aluminum alloy part at a top of the target component, and a grain boundary disordered interface part at an intermediate of the target component.

A 3D solid geometric model of the target component is constructed by utilizing a 3D modeling software, the constructed 3D solid geometric model is sliced and layered by utilizing a slicing software to obtain a series of slice layers stacked one by one, and a corresponding laser printing strategy is set for each slice layer.

A titanium alloy slice data processing file is constructed for each slice layer included in the titanium alloy part, a grain boundary disordered interface slice data processing file is constructed for each slice layer included in the grain boundary disordered interface part, and an aluminum alloy slice data processing file is constructed for each slice layer included in the aluminum alloy part.

In Step 2, laser printing powder is prepared.

The laser printing powder includes three categories, namely titanium alloy powder, grain boundary disordered powder and aluminum alloy powder, the grain boundary disordered powder is made by uniformly mixing the aluminum alloy powder and a boron element, and a mass of the boron element is 0.15 wt. % to 0.25 wt. % of the aluminum alloy powder.

In Step 3, the laser printing is prepared.

The titanium alloy slice data processing file, the grain boundary disordered interface slice data processing file and the aluminum alloy slice data processing file obtained in Step 1 are imported into a control device of laser powder bed fusion forming equipment.

The laser printing powder prepared in Step 2 is placed into a three-tank powder supply system of the laser powder bed fusion forming equipment.

In Step 4, the titanium alloy part is printed and formed.

The titanium alloy slice data processing file is loaded.

The laser powder bed fusion forming equipment is turned on, and the titanium alloy powder is fused and solidified on a substrate layer by layer to form the titanium alloy part under a control of the titanium alloy slice data processing file.

In Step 5, the grain boundary disordered interface is printed and formed.

A processing file is switched to the grain boundary disordered interface slice data processing file.

The laser powder bed fusion forming equipment is turned on, and the grain boundary disordered powder is fused and solidified on the titanium alloy part layer by layer to form the grain boundary disordered interface part under a control of the titanium alloy slice data processing file.

In Step 6, the aluminum alloy part is printed.

The processing file is switched to the aluminum alloy slice data processing file.

The laser powder bed fusion forming equipment is turned on, and the aluminum alloy powder is fused and solidified on the grain boundary disordered interface part layer by layer to form the aluminum alloy part under a control of the aluminum alloy slice data processing file.

Preferably, process forming parameters in the titanium alloy slice data processing file are that: a laser power ranges from 170 W to 180 W, a laser scanning velocity ranges from 900 mm/s to 1000 mm/s, a scanning spacing is 50 μm and a powder laying thickness ranges from 25 μm to 35 μm.

Preferably, process forming parameters in the grain boundary disordered interface slice data processing file are that: a laser power ranges from 170 W to 190 W, a laser scanning velocity ranges from 2400 mm/s to 2600 mm/s, a scanning spacing is 50 μm, a powder laying thickness ranges from 25 μm to 35 μm and the number of formed layers of the grain boundary disordered interface part ranges from 6 layers to 8 layers.

Preferably, process forming parameters in the aluminum alloy slice data processing file are that: a laser power ranges from 180 W to 200 W, a laser scanning velocity ranges from 800 mm/s to 1000 mm/s, a scanning spacing is 50 μm and a powder laying thickness ranges from 25 μm to 35 μm.

Preferably, in Step 4 to Step 6, a partitioned island strategy is adopted by a scanning strategy and a size of an island is 5 mm×5 mm.

Preferably, in Step 4 to Step 6, an oxygen content in a forming cavity is controlled to be lower than 50 ppm.

Preferably, in Step 2, the titanium alloy powder, the aluminum alloy powder and the grain boundary disordered powder are required to be placed in a vacuum drying oven at 80° C. and dried for 10 hours to remove a moisture and improve a powder fluidity.

Another technical objective of the present disclosure is to provide a laser additive manufacturing device for disordering an interface of a high strength and toughness titanium alloy-aluminum alloy heterogeneous material, built based on laser powder bed fusion forming equipment. The device includes a control device, a laser, a galvanometer, a powder supply system and a forming cavity, a three-tank powder supply system is adopted by the powder supply system, the three-tank powder supply system includes three powder supply tanks corresponding to a first powder supply tank, a second powder supply tank and a third powder supply tank, respectively, the first powder supply tank is filled with titanium alloy powder, the second powder supply tank is filled with grain boundary disordered powder, and the third powder supply tank is filled with aluminum alloy powder.

A computer is integrated in the control device, and slice processing files are imported into the computer.

The slice processing files are constructed based on a laser fusion strategy of a target component, and the slice processing files include a titanium alloy slice data processing file, a grain boundary disordered slice data processing file and an aluminum alloy slice data processing file.

The target component is divided into three parts from top to bottom as a whole, and the three parts correspond to a titanium alloy part at a bottom of the target component, an aluminum alloy part at a top of the target component and a grain boundary disordered interface part at an intermediate of the target component.

The titanium alloy slice data processing file is used for fusing and forming the titanium alloy part of the target component layer by layer, each slice layer included in the titanium alloy part is supplied with powder through the first powder supply tank.

The grain boundary disordered slice data processing file is used for fusing and forming the grain boundary disordered interface part of the target component layer by layer, and each slice layer of the grain boundary disordered interface part is supplied with powder through the second powder supply tank.

The aluminum alloy slice data processing file is used for fusing and forming the aluminum alloy part of the target component layer by layer, and each slice layer of the aluminum alloy part is supplied with powder through the third powder supply tank.

Preferably, the grain boundary disordered powder is made by uniformly and mixing aluminum alloy powder and boron element, and a mass of the boron element is 0.15 wt. % to 0.25 wt. % of the aluminum alloy powder.

Based on the above technical objectives, in comparison with the prior art, the present disclosure has the following advantages.
1. In the present disclosure, the heterogeneous interface of the titanium alloy-aluminum alloy heterogeneous material is disordered by utilizing a grain boundary disordering method, which solves the problems such as the poor interface metallurgical bonding, cracks caused by the residual stress concentration and the relative low mechanical property of the titanium alloy-aluminum alloy heterogeneous material due to the brittle ordered intermetallic compounds during the laser additive manufacturing, and implements the laser additive manufacturing and forming of the titanium alloy-aluminum alloy heterogeneous material with the high density and high mechanical property.
2. Different from the traditional heterogeneous material connection processes such as welding and riveting, the laser powder bed fusion technique is innovatively adopted by the present disclosure, which implements the preparation of the integrated heterogeneous material component. This method gives full play to the advantages of laser additive manufacturing in design freedom and structural optimization, significantly reduces the number of the components, simplifies the manufacturing process, shortens the production cycle, effectively reduces the requirements for complex structures such as welding and riveting joints, and significantly improves the lightweight and integrated characteristics of the formed components. The process is suitable for the fields such as aerospace, automobiles, ships, medical that have high requirements for complex structures, fine dimensions and little batch production, and further expands the application scope of the titanium alloy-aluminum alloy heterogeneous material.
3. In the present disclosure, the method of adding grain boundary disordering elements to the Ti-AI system to regulate the ordered intermetallic compound phase can be further extended and applied to the other heterogeneous material systems that are prone to form brittle ordered intermetallic compounds in laser additive manufacturing, so that the scope of the laser additive manufacturing heterogeneous material is expanded, the mechanical property of the laser additive manufacturing heterogeneous material is improved and the development of the laser additive manufacturing technique is promoted.

### BRIEF DESCRIPTION OF THE DRAWINGS

FIG. 1 illustrates a schematic structural diagram of a laser additive manufacturing device for disordering an interface of a high-strength and toughness titanium alloy-aluminum alloy heterogeneous material.

FIG. 2A illustrates a transmission electron microscope image of an interface of a titanium alloy-aluminum alloy heterogeneous material block sample prepared in Example 1, FIG. 2B illustrates a mechanical property curve of the titanium alloy-aluminum alloy heterogeneous material block sample prepared in Example 1.

FIG. 3A illustrates a transmission electron microscope image of an interface of a titanium alloy-aluminum alloy heterogeneous material block sample prepared in Comparative Example 1,

FIG. 3B illustrates a mechanical property curve of the titanium alloy-aluminum alloy heterogeneous material block sample prepared in Comparative Example 1.

FIG. 4A illustrates a transmission electron microscope image of an interface of a titanium alloy-aluminum alloy heterogeneous material block sample prepared in Example 2, FIG. 4B illustrates a mechanical property curve of the titanium alloy-aluminum alloy heterogeneous material block sample prepared in Example 2.

FIG. 5A illustrates a transmission electron microscope image of an interface of a titanium alloy-aluminum alloy heterogeneous material block sample prepared in Example 3, FIG. 5B illustrates a mechanical property curve of the titanium alloy-aluminum alloy heterogeneous material block sample prepared in Example 3.

FIG. 6A illustrates a transmission electron microscope image of an interface of a titanium alloy-aluminum alloy heterogeneous material block sample prepared in Example 4, FIG. 6B illustrates a mechanical property curve of the titanium alloy-aluminum alloy heterogeneous material block sample prepared in Example 4.

FIG. 7A illustrates a transmission electron microscope image of an interface of a titanium alloy-aluminum alloy heterogeneous material block sample prepared in Example 5, FIG. 7B illustrates a mechanical property curve of the titanium alloy-aluminum alloy heterogeneous material block sample prepared in Example 5.

FIG. 8A illustrates a transmission electron microscope image of an interface of a titanium alloy-aluminum alloy heterogeneous material block sample prepared in Example 6, FIG. 8B illustrates a mechanical property curve of the titanium alloy-aluminum alloy heterogeneous material block sample prepared in Example 6.

FIG. 9A illustrates a transmission electron microscope image of an interface of a titanium alloy-aluminum alloy heterogeneous material block sample prepared in Example 7, FIG. 9B illustrates a mechanical property curve of the titanium alloy-aluminum alloy heterogeneous material block sample prepared in Example 7.

FIG. 10A illustrates a transmission electron microscope image of an interface of a titanium alloy-aluminum alloy heterogeneous material block sample prepared in Example 8, FIG. 10B illustrates a mechanical property curve of the titanium alloy-aluminum alloy heterogeneous material block sample prepared in Example 8.

FIG. 11A illustrates a transmission electron microscope image of an interface of a titanium alloy-aluminum alloy heterogeneous material block sample prepared in Example 9, FIG. 11B illustrates a mechanical property curve of the titanium alloy-aluminum alloy heterogeneous material block sample prepared in Example 9.

FIG. 12A illustrates a transmission electron microscope image of an interface of a titanium alloy-aluminum alloy heterogeneous material block sample prepared in Example 10, FIG. 12B illustrates a mechanical property curve of the titanium alloy-aluminum alloy heterogeneous material block sample prepared in Example 10.

FIG. 13A illustrates a transmission electron microscope image of an interface of a titanium alloy-aluminum alloy heterogeneous material block sample prepared in Example 11, FIG. 13B illustrates a mechanical property curve of the titanium alloy-aluminum alloy heterogeneous material block sample prepared in Example 11.

FIG. 14A illustrates a transmission electron microscope image of an interface of a titanium alloy-aluminum alloy heterogeneous material block sample prepared in Example 12, FIG. 14B illustrates a mechanical property curve of the titanium alloy-aluminum alloy heterogeneous material block sample prepared in Example 12.

FIG. 15A illustrates a transmission electron microscope image of an interface of a titanium alloy-aluminum alloy heterogeneous material block sample prepared in Example 13, FIG. 15B illustrates a mechanical property curve of the titanium alloy-aluminum alloy heterogeneous material block sample prepared in Example 13.

In the drawings: 11. First powder supply tank, 12, Second powder supply tank, 13. Third powder supply tank, 2. Galvanometer, 3. Laser, 4. Control device, 5. Forming cavity, 51. Aluminium alloy layer, 52. Grain boundary disordered interface layer, 53. Titanium alloy layer, 54. Titanium alloy substrate, 6. Powder recycling cavity.

### DESCRIPTION OF THE EMBODIMENTS

The technical solutions in the examples of the present disclosure will be clearly and completely described below with reference to the drawings of the examples of the present disclosure. Obviously, the described examples are merely one part of the examples of the present disclosure, rather than all the examples. The following descriptions of at least one exemplary example is actually merely illustrative and have no limitations on the present disclosure and application or utilization thereof in an arbitrary way. Based on the examples in the present disclosure, all other examples obtained by the ordinary technicians in this field without creative efforts are within the protection scope of the present disclosure. Unless otherwise specified, the relative arrangement, expressions and numerical values of the components and steps described in these examples cannot limit the scope of the present disclosure. The techniques, methods and equipment known to the ordinary technicians in the relevant fields may not be discussed in detail, but in appropriate cases, the techniques, methods and equipment should be regarded as one part of the specification. In all implementations shown and discussed here, any specific value should be interpreted as merely exemplary, rather than as the limitations. Therefore, other examples of the exemplary examples may have different values.

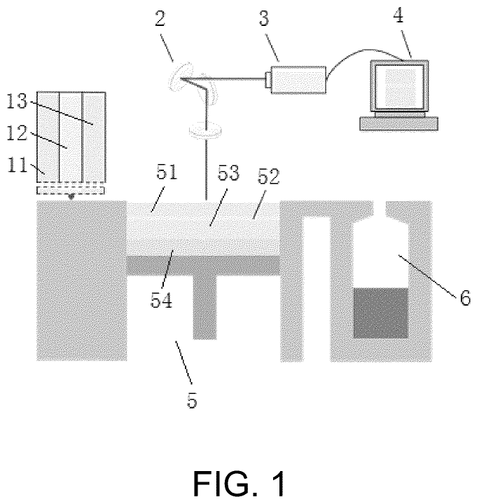

The laser additive manufacturing method for disordering an interface of the high-strength and toughness titanium alloy-aluminum alloy heterogeneous material provided by the present disclosure is implemented based on the laser additive manufacturing device for disordering the interface of the high-strength and toughness titanium alloy-aluminum alloy heterogeneous material as illustrated in FIG. 1. The laser additive manufacturing device for disordering the interface of the high-strength and toughness titanium alloy-aluminum alloy heterogeneous material is built based on the existing laser powder bed fusion forming equipment.

Specifically, the laser powder bed fusion forming equipment includes a control device, a laser, a galvanometer, a powder supply system and a forming cavity. A three-tank supply system is adopted by the powder supply system. The three-tank supply system includes three powder supply tanks, which corresponds to a first powder supply tank, a second powder supply tank and a third powder supply tank. The first powder supply tank is filled with the titanium alloy powder, the second powder supply tank is filled with the grain boundary disordered powder, and the third powder supply tank is filled with the aluminum alloy powder. A computer is integrated in the control device, and slice processing files can be imported into the computer. The powder filled in each powder supply tank of the three-tank powder supply system can be laid on the titanium alloy substrate by the powder laying arm to implement the required powder laying for the current slicing layer, then, the laser beam emitted by the laser is controlled to be projected onto the powder layer corresponding to the current slice layer through the galvanometer for laser fusion according to the control strategy of the corresponding slice processing file, thereby obtaining the current slice layer. Specifically, the slice processing files are constructed based on the laser fusion strategy of the target component, the slice processing files include the titanium alloy slice data processing file, the grain boundary disordered slice data processing file, and the aluminum alloy slice data processing file. The target component is divided into three parts from top to bottom as a whole, which corresponds to the titanium alloy part at the bottom of the target component, the aluminum alloy part at the top of the target component, and the grain boundary disordered interface part at the intermediate of the target component. The titanium alloy slice data processing file is used for laser fusion and forming the titanium alloy part of the target component layer by layer, and each slice layer included in the titanium alloy part is supplied with the powder through the first powder supply tank. The grain boundary disordered slice data processing file is used for laser fusion and forming the grain boundary disordered interface part of the target component layer by layer, and each slice layer of the grain boundary disordered interface part is supplied with the powder through the second powder supply tank. The aluminum alloy slice data processing file is used for laser fusion and forming the aluminum alloy part of the target component layer by layer, and each slice layer of the aluminum alloy part is supplied with the powder through the third powder supply tank.

In the present disclosure, the titanium alloy powder to be used is Ti₆Al₄V, in which the Al content is 5.8 wt. %, the V content is 4.1 wt. %, and the remaining content of Ti₆Al₄V is Ti. The aluminum alloy powder to be used is AlMgScZr, in which the Mg content is 4.2 wt. %, the Sc content is 0.4 wt. %, the Zr content is 0.2 wt. %, and the remaining content of AlMgScZr is Al. The grain boundary disordered powder to be used is AlMgScZr powder prepared by ball milling and contains boron (B) element.

The process for the laser powder bed fusion forming is as follows.
(a) The three slice data processing files of the titanium alloy data processing file, the grain boundary disordered interface processing file and the aluminum alloy data processing file are imported into the computer and the titanium alloy slice data processing file is loaded.
(b) The metal powder corresponding to the current printing layer is laid by a scraper (or powder laying arm) on the titanium alloy substrate to form a powder layer.
(c) The laser is controlled by the control device to generate the laser light to selectively scan a portion of the powder layer, so that the powder is fused and solidified to form a two-dimensional plane solid layer.
(d) The overall forming cavity is driven by the forming cavity driving system to move downward by one powder laying thickness, and Step (b) and Step (c) are repeated until the titanium alloy part is completely formed.
(e) The grain boundary disordered slice data processing file is loaded and Step (b) and Step (c) are repeated until the grain boundary disordered interface part is completely formed.
(f) The aluminum alloy slice data processing file is loaded and Step (b) and Step (c) are repeated until the aluminum alloy part is completely formed.
(g) The component is cut from the substrate by utilizing a wire electrical discharge machining technique, and then ultrasonically cleaned in the acetone to remove the surface stains, so that the titanium alloy-aluminum alloy heterogeneous material component is obtained.

The preparation principle of the present disclosure is to disorder the grain boundary of the intermetallic compounds through an in-situ grain boundary segregation of the B element in the molten pool. On one hand, a disordered layer is formed by the segregation of the B element on the grain boundary of the intermetallic compounds, in comparison with the long-range ordered intermetallic compounds, the disordered layer can increase the antiphase domain boundary energy, enhance the dislocation migration capability and reduce the critical stress of the dislocation transmission to enable the critical stress below the level required for the fracture, so that the plasticity is improved. On the other hand, the disordered B element grain boundary is taken as a buffer zone between the ordered intermetallic compound grains, which can prevent the premature fracture of the ordered intermetallic compound grains and improve the damage resistance of the grain boundary.

The laser additive manufacturing method for disordering the interface of high-strength and toughness titanium alloy-aluminum alloy heterogeneous materials described in the present disclosure will be described in detail below with reference to a plurality of examples.

### Example 1

The laser additive manufacturing method for disordering the interface of high-strength and toughness titanium alloy-aluminum alloy heterogeneous material of the present disclosure comprises the following steps.

### (1) the Grain Boundary Disordered Powder is Prepared.

An appropriate quantity of the aluminum alloy powder is weighed and the B element is weighed by 0.2 wt. % according to the weighed aluminum alloy powder. The weighed aluminum alloy powder and B element are placed in an planetary ball mill protected by the argon to begin to prepare the grain boundary disordered powder by a ball milling, the rotation velocity of the ball milling is 250 rpm, and the time duration of the ball milling time is 4 hours. After ball milling, the grain boundary disordered powder is stored for a subsequent use.

### (2) the Printing Powder is Dried.

The Titanium alloy powder, grain boundary disordered powder and aluminum alloy powder are taken with an appropriate mass and dried in a vacuum drying oven at 80° C. for 10 hours to remove the moisture and improve the fluidity of the powder.

### (3) the Slice Processing Files are Constructed.

A 3D solid geometric model of the target component is constructed by utilizing a 3D modeling software, and the constructed 3D solid geometric model is sliced and layered by utilizing a slicing software to obtain a series of slice layers stacked one by one, and a corresponding laser printing strategy is set for each slice layer.

The target component is formed by three parts from top to bottom as a whole, the three parts correspond to the titanium alloy part at the bottom of the target component, the aluminum alloy part at the top of the component, and the grain boundary disordered interface part at the intermediate of the component.

Each slice layer included in the titanium alloy part is formed by laser-fusing the titanium alloy powder, each slice layer in the grain boundary disordered interface part is formed by laser-fusing the grain boundary disordered powder, and each slice layer included in the aluminum alloy part is formed by laser-fusing the grain boundary aluminum alloy powder.

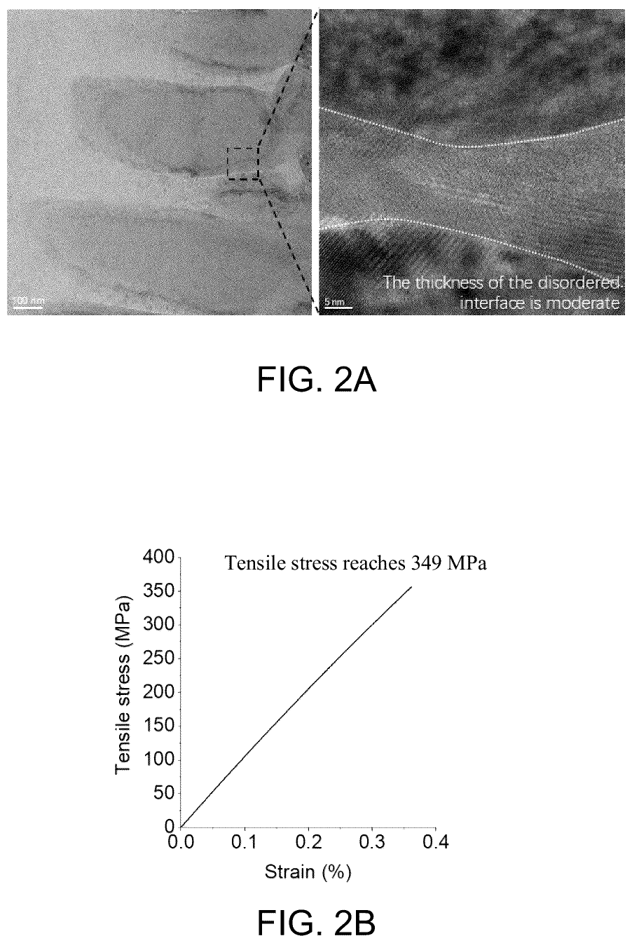

The laser printing strategy of the target component is specifically as follows.
(a) For the titanium alloy part, the laser power is 170 W, the laser scanning velocity is 900 mm/s, the scanning spacing is 50 μm, the powder bed depth is 30 μm, the interlayer rotation is 67°, the partitioned island strategy is adopted and the size of the island is 5 mm×5 mm.
(b) For the grain boundary disordered interface part, the laser power is 180 W, the laser scanning velocity is 2500 mm/s, the scanning spacing 50 μm, the powder laying thickness is 30 μm, the interlayer rotation is 67°, the partitioned island strategy is adopted, the size of the island size is 5 mm×5 mm, and 8 layers are printed and formed.
(c) For the aluminum alloy part, the laser power is 200 W, the laser scanning velocity is 1000 mm/s, the scanning spacing is 50 μm, the powder laying thickness is 30 μm, the interlayer rotation is 67°, the partitioned island strategy is adopted and the size of the island is 5 mm×5 mm.
(4) The slice data processing file in Step (3) is imported into the computer system of the laser powder bed fusion forming equipment, and the titanium alloy powder, grain boundary disordered powder and aluminum alloy powder dried in step (2) are successively loaded into the three-tank powder supply system for forming, and then the high-purity Ar gas is introduced into the laser forming cavity as a protective atmosphere to maintain the oxygen content below 50 ppm.
(5) The titanium alloy slice data processing file is loaded, the laser is turned on, the set powder area is selected according to the path of the slice data processing file for fusion/solidification, and the laser is paused after completing the printing of the titanium alloy part.
(6) The slice data processing file is switched to the grain boundary disordered interface slice data processing file, the laser is turned on, and the laser is paused after completing the printing of the grain boundary disordered interface part.
(7) The slice data processing file is switched to the aluminum alloy slice data processing file, the laser is turned on and the printing of the aluminum alloy part is completed.
(8) After the target component is formed and cooled, the component is separated from the substrate by the wire electrical discharge machining process, then ultrasonically cleaned in the acetone to remove the surface stains, and ground and polished according to the standard metallographic sample preparation procedure to obtain a titanium alloy-aluminum alloy heterogeneous material component with the high density and high mechanical property.
(9) The interface of the intermetallic compounds of the titanium alloy-aluminum alloy heterogeneous material component is sliced by utilizing a focused ion beam, and the interface of the heterogeneous material is observed under a transmission electron microscope as illustrated in FIG. 2A and FIG. 2B.

After observing the transmission electron microscope photograph of the interface of the heterogeneous material in Example 1, it can be found that the interface of the titanium alloy-aluminum alloy heterogeneous material has a good metallurgical bonding, and a disordered grain boundary layer with a thickness of approximately 20 nm formed by the B element between the brittle intermetallic compounds and the substrate is generated. The disordered grain boundary layer can increase the antiphase boundary energy, enhance the dislocation migration ability, and reduce the critical stress of the dislocation transmission to enable the critical stress below the level required for the fracture, so that the mechanical property is improved. In this case, the tensile strength of the sample reaches 349 MPa.

### Comparative Example 1

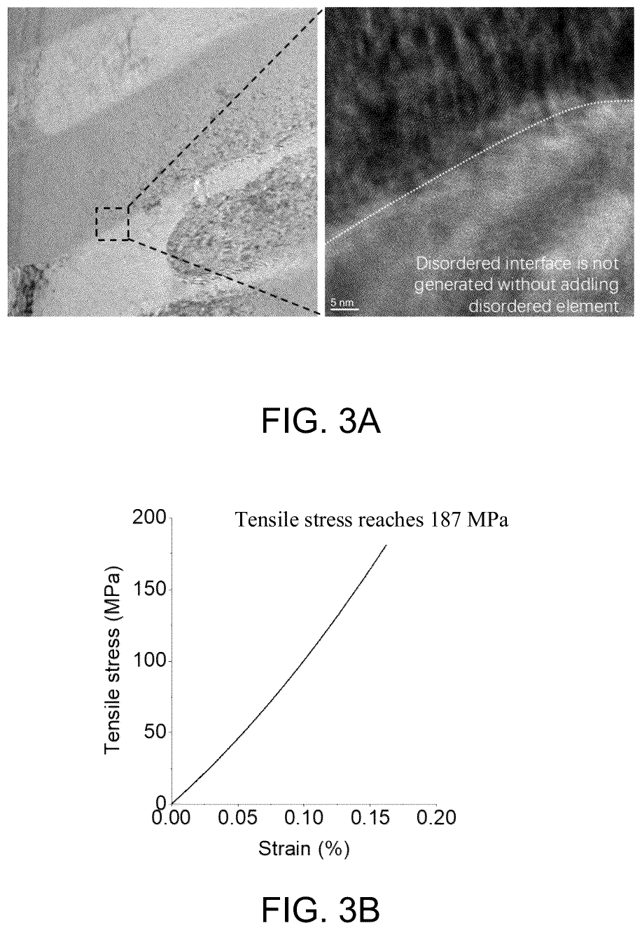

The scheme of Comparative Example 1 is basically the same as that of Example 1, except that the grain boundary disordering method is not utilized in Comparative Example 1, that is, the aluminum alloy part is directly formed after the titanium alloy part is formed. The interface of the intermetallic compounds of the titanium alloy-aluminum alloy heterogeneous material component is sliced by utilizing a focused ion beam, and the interface of the heterogeneous material is observed under a transmission electron microscope as illustrated in FIG. 3A and FIG. 3B.

Through comparing the transmission electron microscope photo and the mechanical property data of the sample obtained in Example 1 with those in Comparative Example 1, it can be found that the disordered interface is not generated between the brittle intermetallic compounds and the substrate in the example without adopting the grain boundary disordering method, and highly ordered brittle intermetallic compounds make the mechanical property of the sample to be poorer, and the tensile strength of the sample is merely 187 MPa.

### Example 2

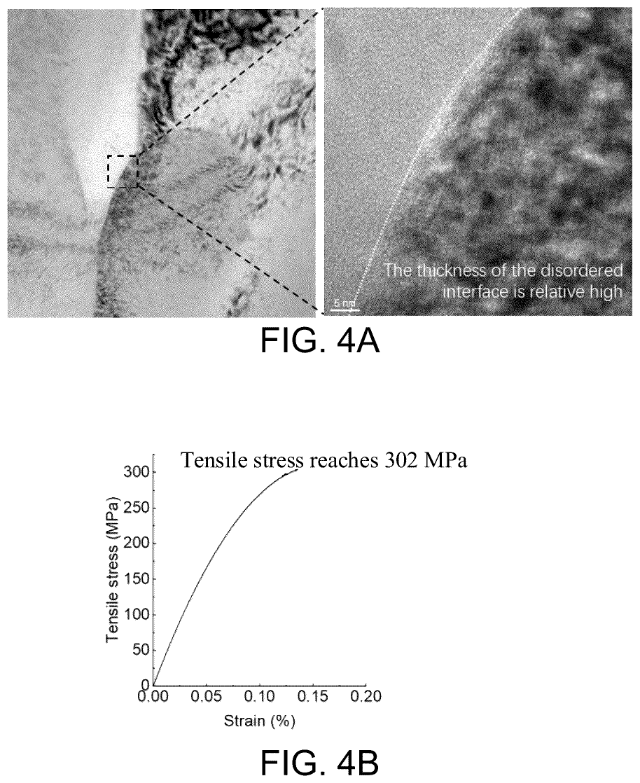

The scheme of Example 2 is basically the same as that of Example 1, the merely difference is that the addition quantity of the B element is increased from 0.2 wt. % to 0.3 wt. %. The interface of the intermetallic compounds of the titanium alloy-aluminum alloy heterogeneous material component is sliced by utilizing a focused ion beam, and the interface of the heterogeneous material is observed under a transmission electron microscope as illustrated in FIG. 4A and FIG. 4B.

Through comparing the transmission electron microscope image and mechanical property data of the sample obtained in Example 2 with those in Example 1, it can be found that, the thickness of the grain boundary disordered interface layer can be increased through increasing the addition quantity of the B element. However, the thickness of the grain boundary disordered layer is increased with the addition quantity of the B element, which is not conducive to the motion and the cross-slip after dislocation movement, and reduces the improvement effect of the mechanical property, and the tensile strength is reduced to 302 MPa. However, the mechanical property is still improved in comparison with the laser fusion-formed component without the grain boundary disordered interface layer.

### Example 3

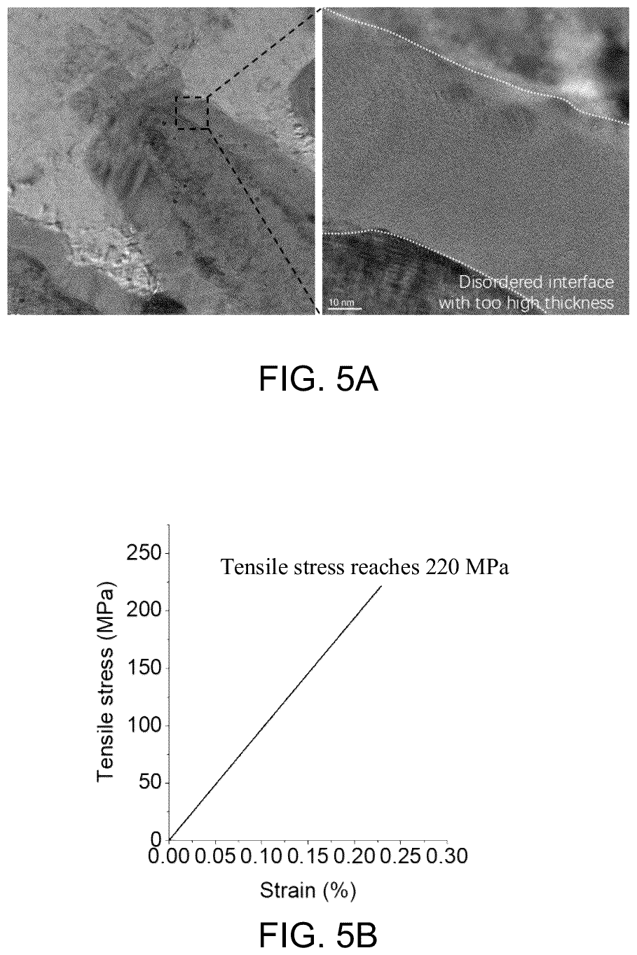

The scheme of Example 3 is basically the same as that of Example 1, the merely difference is that the addition quantity of the B element is increased from 0.2 wt. % to 0.4 wt. %. The interface of the intermetallic compounds of the titanium alloy-aluminum alloy heterogeneous material component is sliced by utilizing a focused ion beam, and the interface of the heterogeneous material is observed under a transmission electron microscope, as illustrated in FIG. 5A and FIG. 5B.

Through comparing the transmission electron microscope image and the mechanical property data of the sample obtained in Example 3 with those in Example 1, it can be found that, the thickness of the grain boundary disordered interface layer can be increased through increasing the addition quantity of the B element. However, the thickness of the grain boundary disordered layer is too high (about 75 nm), which is not conducive to the motion and the cross-slip of after dislocation movement, and reduces the improvement effect of the mechanical property, and the tensile strength is reduced to 220 MPa. However, the mechanical property is still improved in comparison with the laser fusion-formed component without the grain boundary disordered interface layer.

### Example 4

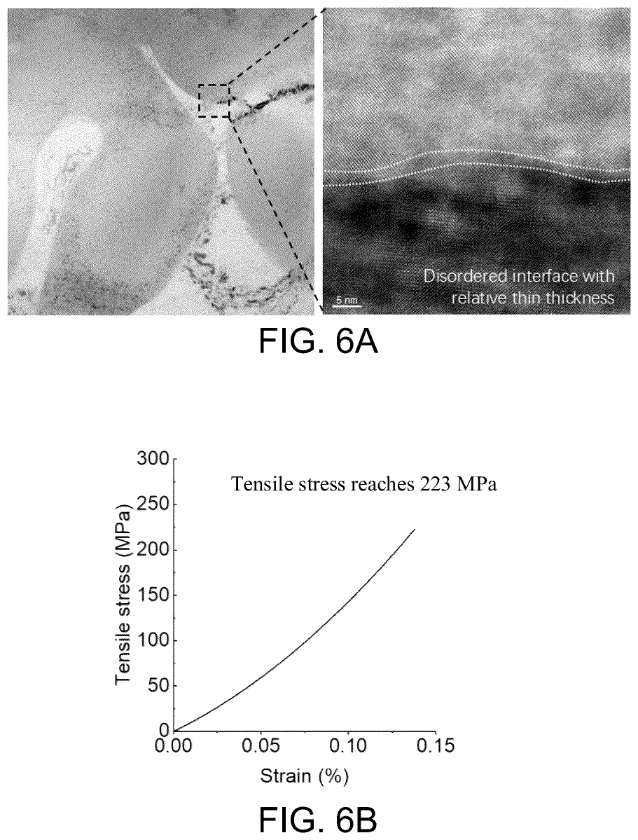

The scheme of Example 4 is basically the same as that of Example 1, the merely difference is that the addition amount of element B is reduced from 0.2 wt. % to 0.1 wt. %. The interface of the intermetallic compounds of the titanium alloy-aluminum alloy heterogeneous material component is sliced by utilizing a focused ion beam, and the interface of the heterogeneous material interface is observed under a transmission electron microscope as illustrated in FIG. 6A and FIG. 6B.

Through comparing the transmission electron microscopy image and the mechanical property data of the sample obtained in Example 4 with those in Example 1, it can be found that, the thickness of the grain boundary disordered interface layer can be reduced by reducing the addition quantity of the B element. However, since the thickness of the grain boundary disordered layer is too thin, the generated improvement effect of the mechanical property is little, and the tensile strength is reduced to 223 MPa. However, the mechanical property is still improved in comparison with the laser fusion-formed component without the grain boundary disordered interface layer.

### Example 5

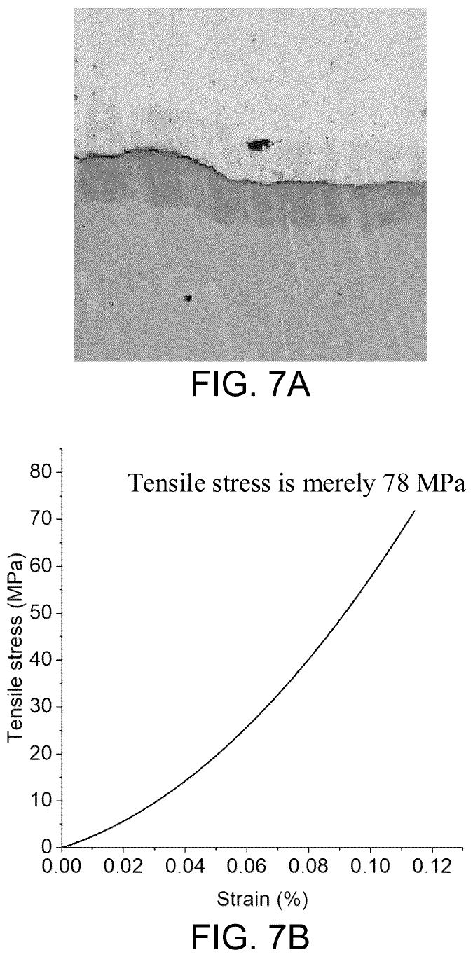

The scheme of Example 5 is basically the same as that of Example 1, the merely difference is that the laser power at the grain boundary disordered interface is increased to 200 W, and the disordered interface is observed by an optical microscope, as illustrated in FIG. 7A and FIG. 7B.

Through comparing the mechanical property data of the sample obtained in Example 5 with that in Example 1, it can be found that, the laser-powder interaction behavior is significantly varied by adding the B element, the degree of the thermal accumulation is increased on the grain boundary disordered interface part at a relative high laser power, so that a microcrack is formed along a direction parallel to the interface and the tensile strength is reduced to 78 MPa.

### Example 6

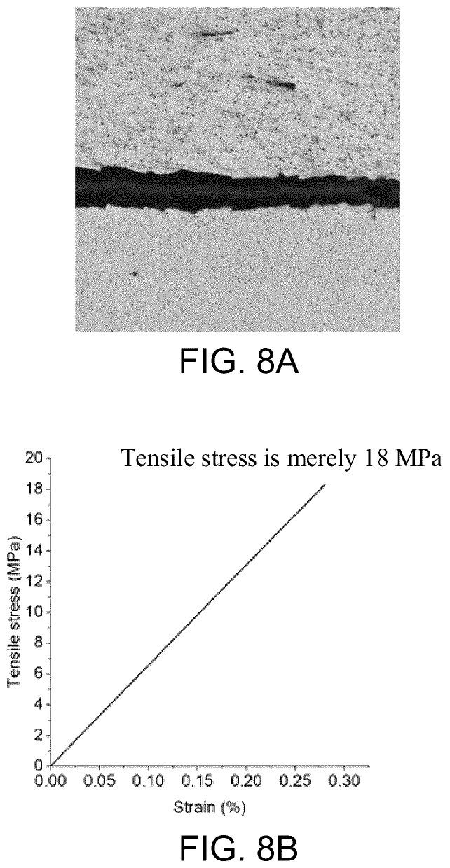

The scheme of Example 6 is basically the same as that of Example 1, the merely difference is that the laser power at the grain boundary disordered interface is further increased to 220 W, and the disordered interface is observed by an optical microscope, as illustrated in FIG. 8A and FIG. 8B.

Through comparing the mechanical property data of the sample obtained in Example 6 with that in Example 1, it can be found that, the laser-powder interaction behavior is significantly varied by increasing the B element, the degree of the thermal accumulation is further increased on the grain boundary disordered interface part at a higher laser power, so that a through-crack micro-crack is formed along a direction parallel to the interface and the tensile strength is merely 18 MPa.

### Example 7

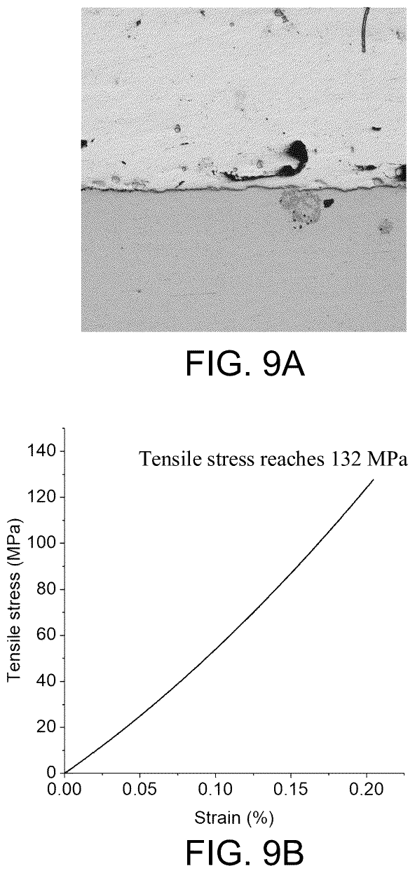

The scheme of Example 7 is basically the same as that of Example 1, the merely difference is that the laser power at the grain boundary disordered interface is reduced to 160 W, and the disordered interface is observed by an optical microscope, as illustrated in FIG. 9A and FIG. 9B.

Through comparing the mechanical property data of the sample obtained in Example 7 with that in Example 1, it can be found that although the cracking problem caused by different thermal expansion coefficients can be alleviated by reducing the laser energy input, a little quantity of unfused defects are generated in the disordered interface layer due to the insufficient energy input, and the tensile strength is merely 132 MPa.

### Example 8

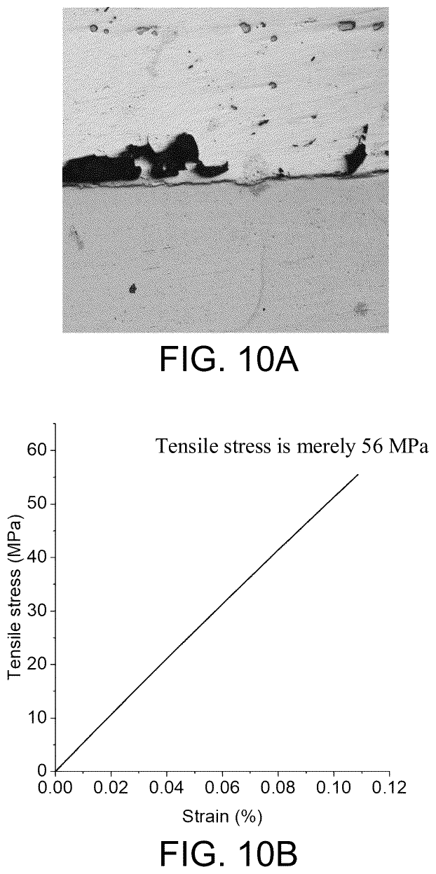

The scheme of Example 8 is basically the same as that of Example 1, the merely difference is that the laser power at the grain boundary disordered interface is further reduced to 140 W, and the grain boundary disordered interface is observed by an optical microscope, as illustrated in FIG. 10A and FIG. 10B.

Through comparing the mechanical property data of the sample obtained in Example 8 with that in Example 1, it can be found that, the laser energy input is further reduced, which results in the fact that the mechanical property is reduced by a large quantity of unfused defects generated in the grain boundary disordered interface layer, and the tensile strength is merely 56 MPa.

### Example 9

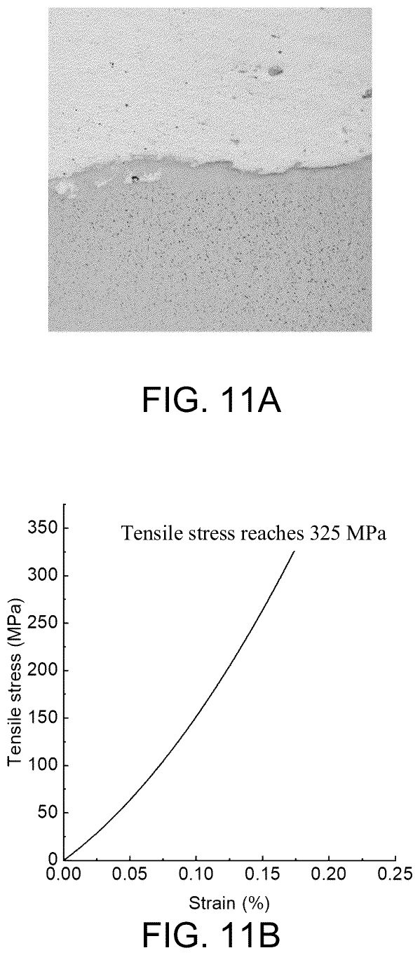

The scheme of Example 9 is basically the same as that of Example 1, the merely difference is that the laser power of the grain boundary disordered interface is 170 W, and the grain boundary disordered interface is observed by an optical microscope, as illustrated in FIG. 11A and FIG. 11B.

Through comparing the mechanical property data of the samples obtained in Example 9 with that in Example 1, it can be found that, under the process parameters, the multi-material interface has an excellent metallurgical bonding, the residual stress is moderate, and the tensile strength reaches 325 MPa.

### Example 10

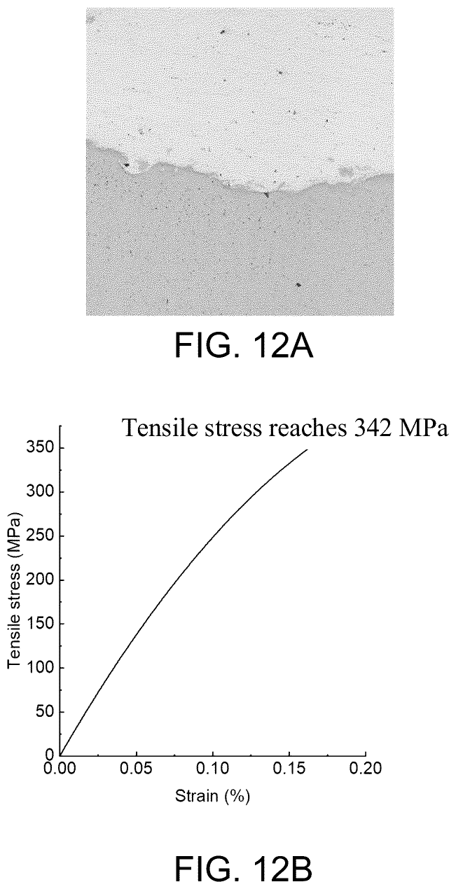

The scheme of Example 10 is basically the same as that of Example 1, the merely difference is that the laser power of the grain boundary disordered interface is 190 W, and the grain boundary disordered interface is observed by an optical microscope, as illustrated in FIG. 12A and FIG. 12B.

Through comparing the mechanical property data of the sample obtained in Example 10 with that in Example 1, it can be found that, the multi-material interface has a good metallurgical bonding, the residual stress is moderate and the tensile strength reaches 342 MPa.

### Example 11

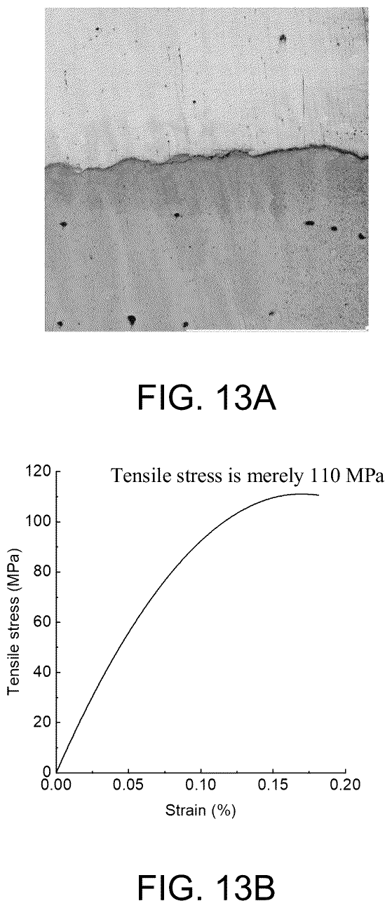

The scheme of Example 11 is basically the same as that of Example 1, the merely difference is that the number of formed layers of the grain boundary disordered interface part is reduced to 5 layers, and the grain boundary disordered interface is observed by an optical microscope, as illustrated in FIG. 13A and FIG. 13B.

Through comparing the mechanical property data of the sample obtained in Example 11 with that in Example 1, it can be found that, after the number of the layers of the grain boundary disordered interface is increased, the effects of relieving the residual stress and improving the dislocation movement generated by the relative thin grain boundary disordered interface, are not enough to offset the thermal stress in the laser additive manufacturing process, and a crack is generated in the multi-material sample along a direction parallel to the interface, and the tensile strength is merely 110 MPa.

### Example 12

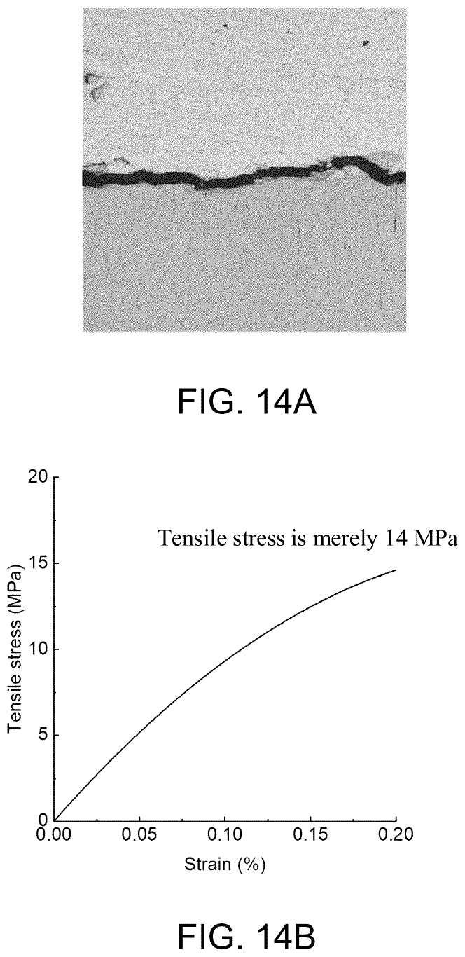

The scheme of Example 12 is basically the same as that of Example 1, the merely difference is that the number of formed layers of the grain boundary disordered interface part is reduced to 3 layers, and the grain boundary disordered interface is observed by an optical microscope, as illustrated in FIG. 14A and FIG. 14B.

Through comparing the mechanical property data of the sample obtained in Example 12 with that in Example 1, it can be found that, similar to Example 11, the effects is further reduced after the number of the layers of the grain boundary disordered interface part is further reduced, and the width of the crack generated in the multi-material sample along a direction parallel to the interface is larger, and the tensile strength is merely 14 MPa.

### Example 13

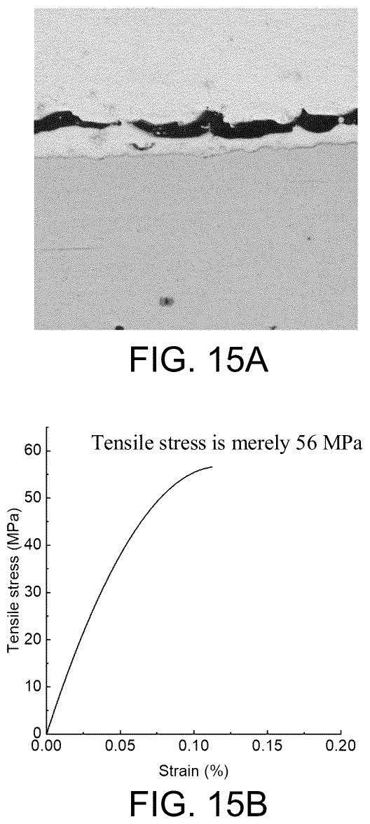

The scheme of Example 13 is basically the same as that of Example 1, the merely difference is that the number of the formed layers of the grain boundary disordered interface part is increased to 10 layers, the grain boundary disordered interface is observed by an optical microscope, as illustrated in FIG. 15A and FIG. 15B.

Through comparing the mechanical property of the sample obtained in Example 13 with that in Example 1, it can be found that, although the metallurgical bonding of the multi-material can still be implemented at the bottom of the grain boundary disordered interface part after the number of the layers of the grain boundary disordered interface part is increased, the top part of the grain boundary disordered interface part is far away from the titanium alloy part, and the heat conduction velocity is accelerated, which results in the fact that the this part is heated less, and the energy is insufficient, so that a relative more unfused defects are generated, and the tensile strength is merely 56 MPa.

Through comparing the tensile strength of the titanium alloy-aluminum alloy heterogeneous material component obtained in the above-mentioned Example 1 to Example 13 with that in Comparative Example 1, it can be seen that, in order to obtain the laser-printed components with excellent mechanical property, it is not only necessary to consider adding a grain boundary disordered interface layer between the titanium alloy slice layer and the aluminum alloy slice layer, but also to pay special attention to the process forming parameters of the molten grain boundary disordered interface (especially the setting of the laser power), so that the problems such as the poor interface metallurgical bonding, cracks caused by residual stress concentration and relative low mechanical property of the titanium alloy-aluminum alloy heterogeneous material due to the brittle ordered intermetallic compounds during the laser additive manufacturing are solved, and the laser additive manufacturing and forming of the titanium alloy-aluminum alloy heterogeneous material with high density and high mechanical property are implemented.

An idea and a method for the laser additive manufacturing method for disordering the interface of the high-strength and toughness titanium alloy-aluminum alloy heterogeneous material are provided in the present disclosure. There are many methods and ways to implement the technical solutions. The above is merely the preferred examples of the present disclosure. It should be pointed out that for ordinary technicians in this technical field, a plurality of improvements and modifications can be made without departing from the principle of the present disclosure. These improvements and modifications should also be regarded as the protection scope of the present disclosure. All components not specified in the examples can be implemented by the existing techniques.

What is claimed is:

1. A laser additive manufacturing method for disordering an interface of a high-strength and toughness titanium alloy-aluminum alloy heterogeneous material, comprising following steps:
step 1, integrally planning a laser printing strategy for a target component:
dividing the target component into three parts from top to bottom as a whole, wherein the three parts correspond to a titanium alloy part at a bottom of the target component, an aluminum alloy part at a top of the target component, and a grain boundary disordered interface part at an intermediate of the target component,
constructing, by utilizing a 3D modeling software, a 3D solid geometric model of the target component; slicing and layering, by utilizing a slicing software, the constructed 3D solid geometric model to obtain a series of slice layers stacked one by one; and setting a corresponding laser printing strategy for each slice layer; and
constructing a titanium alloy slice data processing file for each slice layer included in the titanium alloy part; constructing a grain boundary disordered interface slice data processing files for each slice layer included in the grain boundary disordered interface part; and constructing an aluminum alloy slice data processing file for each slice layer included in the aluminum alloy part;
step 2: preparing laser printing powder:
wherein the laser printing powder includes three categories, namely titanium alloy powder, grain boundary disordered powder and aluminum alloy powder, the grain boundary disordered powder is made by uniformly mixing the aluminum alloy powder and a boron element, and a mass of the boron element is 0.15 wt. % to 0.25 wt. % of the aluminum alloy powder;
step 3: preparing the laser printing:
importing the titanium alloy slice data processing file, the grain boundary disordered interface slice data processing file and the aluminum alloy slice data processing file obtained in step 1 into a control device of laser powder bed fusion forming equipment; and
placing the laser printing powder prepared in step 2 into a three-tank powder supply system of the laser powder bed fusion forming equipment;
step 4: printing and forming the titanium alloy part:
loading the titanium alloy slice data processing file;
turning on the laser powder bed fusion forming equipment, fusing and solidifying, under a control of the titanium alloy slice data processing file, the titanium alloy powder layer by layer on a substrate to form the titanium alloy part;
step 5: printing and forming the grain boundary disordered interface;
switching a processing file to the grain boundary disordered interface slice data processing file; and
turning on the laser powder bed fusion forming equipment, fusing and solidifying, under a control of the grain boundary disordered interface slice data processing file, the grain boundary disordered powder layer by layer on the titanium alloy part to form the grain boundary disordered interface part; and
step 6: printing the aluminum alloy part:
switching the processing file to the aluminum alloy slice data processing file; and
turning on the laser powder bed fusion forming equipment, fusing and solidifying, under a control of the aluminum alloy slice data processing file, the aluminum alloy powder layer by layer on the grain boundary disordered interface part to form the aluminum alloy part.

2. The laser additive manufacturing method for disordering the interface of the high-strength and toughness titanium alloy-aluminum alloy heterogeneous material according to claim 1, wherein process forming parameters in the titanium alloy slice data processing file are that: a laser power ranges from 170 W to 180 W, a laser scanning velocity ranges from 900 mm/s to 1000 mm/s, a scanning spacing is 50 μm and a powder laying thickness ranges from 25 μm to 35 μm.

3. The laser additive manufacturing method for disordering the interface of the high-strength and toughness titanium alloy-aluminum alloy heterogeneous material according to claim 1, wherein process forming parameters in the grain boundary disordered interface slice data processing file are that: a laser power ranges from 170 W to 190 W, a laser scanning velocity ranges from 2400 mm/s to 2600 mm/s, a scanning spacing is 50 μm, a powder laying thickness ranges from 25 μm to 35 μm and a number of formed layers of the grain boundary disordered interface part ranges from 6 layers to 8 layers.

4. The laser additive manufacturing method for disordering the interface of the high-strength and toughness titanium alloy-aluminum alloy heterogeneous material according to claim 1, wherein process forming parameters in the aluminum alloy slice data processing file are that: a laser power ranges from 180 W to 200 W, a laser scanning velocity ranges from 800 mm/s to 1000 mm/s, a scanning spacing is 50 μm and a powder laying thickness ranges from 25 μm to 35 μm.

5. The laser additive manufacturing method for disordering the interface of the high-strength and toughness titanium alloy-aluminum alloy heterogeneous material according to claim 1, wherein in step 4 to step 6, a partitioned island strategy is adopted by a scanning strategy and a size of an island is 5 mm×5 mm.

6. The laser additive manufacturing method for disordering the interface of the high-strength and toughness titanium alloy-aluminum alloy heterogeneous material according to claim 1, wherein in step 4 to step 6, an oxygen content in a forming cavity is controlled to be lower than 50 ppm.

7. The laser additive manufacturing method for disordering the interface of the high-strength and toughness titanium alloy-aluminum alloy heterogeneous material according to claim 1, wherein in step 2, the titanium alloy powder, the aluminum alloy powder, and the grain boundary disordered powder are required to be placed in a vacuum drying oven at 80° C. and dried for 10 hours to remove a moisture and improve a powder fluidity.

8. A laser additive manufacturing device for disordering an interface of a high-strength and toughness titanium alloy-aluminum alloy heterogeneous material, for implementing the laser additive manufacturing method for disordering the interface of the high-strength and toughness titanium alloy-aluminum alloy heterogeneous material according to claim 1, built based on laser powder bed fusion forming equipment, including a control device, a laser, a galvanometer, a powder supply system and a forming cavity, wherein a three-tank powder supply system is adopted by the powder supply system, the three-tank supply system includes three powder supply tanks, the three powder supply tanks correspond to a first powder supply tank, a second powder supply tank and a third powder supply tank, respectively, the first powder supply tank is filled with titanium alloy powder, the second powder supply tank is filled with grain boundary disordered powder, and the third powder supply tank is filled with aluminum alloy powder;
a computer is integrated in the control device, and slice processing files are imported into the computer;
the slice processing files are constructed based on a laser fusion strategy of a target component, the slice processing files include a titanium alloy slice data processing file, a grain boundary disordered slice data processing file and an aluminum alloy slice data processing file;
the target component is divided into three parts from top to bottom as a whole, and the three parts correspond to a titanium alloy part at a bottom of the target component, an aluminum alloy part at a top of the target component and a grain boundary disordered interface part at an intermediate of the target component;
the titanium alloy slice data processing file is used for fusing and forming the titanium alloy part of the target component layer by layer, each slice layer included in the titanium alloy part is supplied with powder through the first powder supply tank;
the grain boundary disordered slice data processing file is used for fusing and forming the grain boundary disordered interface part of the target component layer by layer, and each slice layer of the grain boundary disordered interface part is supplied with powder through the second powder supply tank; and
the aluminum alloy slice data processing file is used for fusing and forming the aluminum alloy part of the target component layer by layer, and each slice layer of the aluminum alloy part is supplied with powder through the third powder supply tank.
